(19) United States
(12) Patent Application Publication
(10) Pub. No.: US 2024/0090517 A1
(43) Pub. Date: Mar. 21, 2024

(54) Microbiocidal Control in The Processing of Poultry

(71) Applicant: Albemarle Corporation, Charlotte, NC (US)

(72) Inventors: Eric W. Liimatta, Baton Rouge, LA (US); Laura B. Gage, Lawrence, NJ (US)

(21) Appl. No.: 18/522,603

(22) Filed: Nov. 29, 2023

Related U.S. Application Data
(63) Continuation of application No. 15/545,400, filed on Jul. 21, 2017, now abandoned.
(60) Provisional application No. 62/106,824, filed on Jan. 23, 2015.

(51) Int. Cl. A22C 21/00; A01N 25/02; A01N 37/16; A01N 43/50; A01N 59/00; A23B 4/20; A23B 4/24

(52) U.S. Cl. CPC A22C 21/0061; A01N 25/02; A01N 37/16; A01N 43/50; A01N 59/00; A23B 4/20; A23B 4/24; A23V 2002/00

(57) ABSTRACT

This invention provides processes comprising
contacting at least one unopened defeathered poultry carcass with water containing a microbiocidal composition, optionally opening and eviscerating at least one unopened defeathered poultry carcass that was wetted;
subjecting at least one eviscerated poultry carcass to inside-outside washing with water containing a microbiocidal composition;
placing at least one eviscerated poultry carcass in a chill tank into contact with chill water containing a microbiocidal composition;
contacting parts of poultry resulting from processing of poultry containing a microbiocidal composition.
   The water in these processes contains a microbiocidal composition comprising I) one or more surfactants and II) a microbiocidal amount of a biocide. The surfactants include amine oxides and/or betaines. The biocides include various chlorine-based and bromine-based biocides; chlorine dioxide; and peracetic acid.

### REFERENCE TO RELATED APPLICATIONS

This application a Continuation of U.S. application Ser. No. 15/545,400, filed Jul. 21, 2017, which is the National Stage of International Patent Application No. PCT/US2016/013262, filed on Jan. 13, 2016, which application claims priority from U.S. Application No. 62/106,824, filed on Jan. 23, 2015, the disclosures of which are incorporated herein by reference.

### TECHNICAL FIELD

This invention relates to application of microbiocides and surfactants to poultry

### BACKGROUND

Poultry processing is an area in which microbiological control is of vital importance. By the very nature of the processing involved, there are numerous opportunities for the poultry to be exposed to various pathogens. Contamination of poultry meat products with various pathogens such as species of Listeria, Escherichia, Salmonella, Campylobacter, and others, is a problem that has existed for many years.

A need exists for a way of providing more effective microbiocidal control in the processing of poultry.

### SUMMARY OF THE INVENTION

This invention provides combinations of microbiocides and surfactants that have enhanced microbiocidal efficacy, especially against Campylobacter. The increased efficacy allows greater microbiocidal control while using less microbiocide. The use of reduced levels of biocide to achieve higher levels of efficacy in turn reduces the amount of biocide residues, if any, in the product while still achieving food safety goals.

Embodiments of this invention include processes which comprise
contacting at least one unopened defeathered poultry carcass with water containing a microbiocidal composition, whereby the exterior of said carcass is wetted by such composition; optionally opening and eviscerating at least one unopened defeathered poultry carcass that was wetted and subjecting the opened and eviscerated poultry carcass to inside-outside washing with a microbiocidally-effective amount of microbiocidal composition;
subjecting at least one eviscerated poultry carcass to inside-outside washing with water containing a microbiocidal composition; optionally placing the carcass that was subjected to inside-outside washing in a chill tank into contact with chill water, characterized in that the chill water contains a microbiocidal composition;
placing at least one eviscerated poultry carcass in a chill tank and into contact with chill water containing a microbiocidal composition, optionally contacting parts of poultry resulting from the processing of poultry with water containing a microbiocidal composition;
contacting parts of poultry resulting from processing of poultry with water containing a microbiocidal composition.
   All of these processes are characterized in that the water contains a microbiocidal composition comprising I) one or more surfactants, and II) a microbiocidal amount of a biocide. The biocides are selected from II) a microbiocidal amount of: (1) one or more 1,3-dibromo-5,5-dialkylhydantoins; (2) one or more N,N′-bromochloro-5,5-dialkylhydantoins; (3) chlorine dioxide; (4) chlorine; (5) hypochlorous acid formed by electrolysis; (6) one or more alkali metal hypochlorites and/or one or more alkaline earth metal hypochlorites; (7) monochloramine; (8) peracetic acid; (9) a bromine-based biocide formed in water from
A) (i) bromine chloride or bromine chloride and bromine, with or without conjoint use of chlorine, and (ii) overbased alkali metal salt of sulfamic acid and/or sulfamic acid, alkali metal base, and water, wherein (i) and (ii) are in relative proportions such that there is an atom ratio of nitrogen to active bromine greater than 0.93, and wherein the bromine-based biocide has a pH of greater than 7; or
B) (i) one or more bromide sources selected from ammonium bromide, hydrogen bromide, one or more alkali metal bromides, one or more alkaline earth metal bromides, and mixtures of any two or more of the foregoing, (ii) a chlorine source, (iii) optionally at least one inorganic base, and (iv) optionally sulfamic acid and/or a metal salt of sulfamic acid.
   The surfactants are one or more amine oxides having about eight to about twenty carbon atoms, and/or one or more betaines having about eight to about twenty carbon atoms.

These procedures provide very effective microbiocidal control and do not adversely affect the appearance, quality, or taste of the poultry meat product.

These and other embodiments and features of this invention will be still further apparent from the ensuing description and appended claims.

### FURTHER DETAILED DESCRIPTION OF THE INVENTION

As used throughout this document, the phrase “microbiocidal amount” denotes that the amount used controls, kills, or otherwise reduces the bacterial or microbial content of the poultry being treated by a statistically significant amount.

The term ppm means parts per million (wt/wt), unless specifically stated otherwise herein.

The phrase “water to be applied to the poultry”, as used throughout this document, refers to water that comes into contact with poultry, whether via spraying dipping, immersion, or other methods.

Throughout this document, the phrase “processing of poultry” refers to poultry processing steps, which include one or more of: slaughtering poultry; defeathering one or more poultry carcasses; opening and eviscerating one or more poultry carcasses; inside-outside washing of one or more poultry carcasses; and placing one or more poultry carcasses in a chill tank.

Surfactants compatible with biocides, even with bleach, are known in the art; see U.S. Pat. No. 6,506,718. However, not all surfactants increase the microbiocidal efficacy of the microbiocide/surfactant combinations.

Preferably, the biocides listed above are the sole sources of microbiocidal activity in the water used pursuant to this invention. This invention includes use in water treated with the biocides listed above and one or more other microbiocidal agents that are compatible therewith.

The 1,3-dibromo-5,5-dialkylhydantoins and N,N′-bromochloro-5,5-dialkylhydantoins used pursuant to this invention are solids, and can be blended directly into the water to be applied to the poultry. If desired, the 1,3-dibromo-5,5-dialkylhydantoin(s) and N,N′-bromochloro-5,5-dialkylhydantoin(s) can be pre-mixed with water, and optionally with the surfactant, prior to introduction into the water to be applied to the poultry. In the water to be applied to the poultry, a microbiocidal amount of one or more 1,3-dibromo-5,5-dialkylhydantoins or one or more N,N′-bromochloro-5,5-dialkylhydantoins is typically enough to provide a bromine residual in a range of about 10 ppm to about 450 ppm (wt/wt) as free bromine, preferably in a range of about 20 to about 300 ppm (wt/wt) as free bromine, and more preferably in a range of about 35 to about 100 ppm (wt/wt) as free bromine.

In the practice of this invention, the one or more 1,3-dibromo-5,5-dialkylhydantoins have alkyl groups containing one to about 4 carbon atoms. Preferred are 1,3-dibromo-5,5-dialkylhydantoins in which one of the alkyl groups is a methyl group and the other alkyl group contains in the range of 1 to about 4 carbon atoms. Thus, preferred 1,3-dibromo-5,5-dialkylhydantoins include 1,3-dibromo-5,5-dimethylhydantoin, 1,3-dibromo-5-ethyl-5-methylhydantoin, 1,3-dibromo-5-n-propyl-5-methylhydantoin, 1,3-dibromo-5-isopropyl-5-methylhydantoin, 1,3-dibromo-5-n-butyl-5-methylhydantoin, 1,3-dibromo-5-isobutyl-5-methylhydantoin, 1,3-dibromo-5-sec-butyl-5-methylhydantoin, 1,3-dibromo-5-tert-butyl-5-methylhydantoin, and mixtures of any two or more of them. Of these biocidal agents, 1,3-dibromo-5-isobutyl-5-methylhydantoin, 1,3-dibromo-5-n-propyl-5-methylhydantoin, and 1,3-dibromo-5-ethyl-5-methylhydantoin are preferred from a cost effectiveness standpoint. For mixtures of the foregoing 1,3-dibromo-5,5-dialkylhydantoins, it is preferred to use 1,3-dibromo-5,5-dimethylhydantoin as one of the components, with a mixture of 1,3-dibromo-5,5-dimethylhydantoin and 1,3-dibromo-5-ethyl-5-methylhydantoin being more preferred. A particularly preferred 1,3-dibromo-5,5-dialkylhydantoin is 1,3-dibromo-5,5-dimethylhydantoin.

Methods for producing 1,3-dibromo-5,5-dialkylhydantoins are known and reported in the literature, and some of them are available commercially. For example, 1,3-dibromo-5,5-dimethylhydantoin is available under the trade designations XtraBrom® 111 biocide and XtraBrom® T biocide (Albemarle Corporation).

The one or more N,N′-bromochloro-5,5-dialkylhydantoins used in the practice of this invention are N,N′-bromochloro-5,5-dialkylhydantoins in which each alkyl group independently contains in the range of 1 to about 4 carbon atoms. Suitable compounds of this type include, for example, such compounds as N,N′-bromochloro-5,5-dimethylhydantoin, N,N′-bromochloro-5-ethyl-5-methylhydantoin, N,N′-bromochloro-5-propyl-5-methylhydantoin, N,N′-bromochloro-5-isopropyl-5-methylhydantoin, N,N′-bromochloro-5-butyl-5-methylhydantoin, N,N′-bromochloro-5-isobutyl-5-methylhydantoin, N,N′-bromochloro-5-sec-butyl-5-methylhydantoin, N,N′-bromochloro-5-tert-butyl-5-methylhydantoin, N,N′-bromochloro-5,5-diethylhydantoin, and mixtures of any two or more of the foregoing. Most preferred is N,N′-bromochloro-5,5-dimethylhydantoin.

When a mixture of two or more N,N′-bromochloro-5,5-dialkylhydantoin biocides is used pursuant to this invention, the individual biocides of the mixture can be in any proportions relative to each other. Minor proportions (less than 50 wt %) of mono-N-bromo-5,5-dialkylhydantoin(s) can also be present, either with such mixtures of two or more N,N′-bromochloro-5,5-dialkylhydantoin biocides, or with only one N,N′-bromochloro-5,5-dialkylhydantoin biocide. One suitable mixture has a predominate amount by weight of N,N′-bromochloro-5,5-dimethylhydantoin together with a minor proportion by weight of 1,3-dichloro-5,5-dimethylhydantoin and 1,3-dichloro-5-ethyl-5-methylhydantoin.

Methods for producing such N,N′-bromochloro-5,5-dialkylhydantoins are known and reported in the literature, and some of them are available commercially. For example, N,N′-bromochloro-5,5-dimethylhydantoin is available commercially under the trade designation Bromicide® biocide (BWA Water Additives UK Limited). A mixture that is available under the trade designation Dantobrom® biocide (Lonza Corporation) is believed to contain about 60 wt % of N,N′-bromochloro-5,5-dimethylhydantoin, about 27.4 wt % of 1,3-dichloro-5,5-dimethylhydantoin, about 10.6 wt % of 1,3-dichloro-5-ethyl-5-methylhydantoin, and about 2 wt % of inert ingredients.

Chlorine dioxide is usually made shortly before use. The surfactants are introduced after the chlorine dioxide has been formed. The chlorine dioxide can be made in situ in the water to be applied to the poultry, or made in a separate vessel and then introduced into the water to be applied to the poultry. When the chlorine dioxide has been formed in a separate vessel, the surfactants can be added to the separate vessel or directly into the water to be applied to the poultry. For chlorine dioxide, the microbiocidal amount in the water to be applied to the poultry is about 3 ppm (wt/wt) or less as residual chlorine dioxide.

Chlorine (Cl₂) is a gas, and is either introduced directly into the water to be applied to the poultry, or, preferably, into a separate solution. The surfactant(s) can be introduced into the into the water to be applied to the poultry, or more preferably, into a separate solution into which chlorine is also introduced.

Hypochlorous acid formed by electrolysis is formed from aqueous sodium chloride, which when electrolyzed forms an aqueous solution of sodium hydroxide and an aqueous solution of hypochlorous acid; the aqueous solution of hypochlorous acid is used. The aqueous solution of hypochlorous acid can be introduced into the water to be applied to the poultry, and the surfactant can also be introduced directly into the water to be applied to the poultry, or the surfactant can be introduced into the aqueous solution of hypochlorous acid, which is then combined with the water to be applied to the poultry.

Various alkali metal hypochlorites or alkaline earth metal hypochlorites can be used in the practice of this invention, and include lithium hypochlorite, sodium hypochlorite, potassium hypochlorite, calcium hypochlorite, magnesium hypochlorite, and the like. Of the alkali metal hypochlorites or alkaline earth metal hypochlorites, lithium hypochlorite, sodium hypochlorite, and calcium hypochlorite are preferred; sodium hypochlorite and calcium hypochlorite are more preferred. Hypochlorites of Be, Sr, or Ba should not be used because of toxicological concerns. Thus, the term “alkaline earth” as used herein excludes Be, Sr, and Ba.

Monochloramine is also referred to as chloramine or chloramide. An aqueous solution of monochloramine can be prepared and then combined with the water to be applied to the poultry. The surfactant(s) can be introduced directly into the water to be applied to the poultry, or into an aqueous solution of monochloramine, which is then combined with the water to be applied to the poultry.

Chlorine, hypochlorous acid formed by electrolysis, one or more alkali metal hypochlorites and/or one or more alkaline earth metal hypochlorites, and monochloramine are preferably used in amounts that provide a chlorine residual of in a range of about 4 ppm to about 200 ppm (wt/wt) as free chlorine, preferably in a range of about 8 to about 135 ppm (wt/wt) as free chlorine, and more preferably in a range of about 15 to about 45 ppm (wt/wt) as free chlorine, in the water to be applied to the poultry.

Peracetic acid, also called peroxyacetic acid, is usually in admixture with acetic acid; this mixture is a liquid at ambient conditions. The peracetic acid can be blended directly into the water to be applied to the poultry, or pre-mixed with the surfactant(s) and/or water prior to introduction into the water to be applied to the poultry. The microbiocidal amount of peracetic acid is in a range of about 1 ppm to about 500 ppm (wt/wt), preferably in a range of about 5 ppm to about 250 ppm (wt/wt), more preferably in a range of about 10 ppm to about 100 ppm (wt/wt), still more preferably in a range of about 15 ppm to about 75 ppm (wt/wt), and even more preferably in a range of about 15 ppm to about 50 ppm (wt/wt).

Bromine-based biocides A) and B) contain active bromine, also referred to as a bromine residual.

Bromine-based biocides of A) are formed in water from (i) bromine chloride or bromine chloride and bromine, with or without conjoint use of chlorine, and (ii) overbased alkali metal salt of sulfamic acid and/or sulfamic acid, alkali metal base, and water, wherein (i) and (ii) are in relative proportions such that there is an atom ratio of nitrogen to active bromine greater than 0.93, and wherein the bromine-based biocide has a pH of greater than 7. Bromine-based biocide A) can be made in the water to be applied to the poultry, or preferably, as a separate, more concentrated aqueous solution which is introduced into the water to be applied to the poultry. When bromine-based biocide A) is prepared as a separate solution, the surfactant can be introduced into the separate solution (preferred) or into the water to be applied to the poultry.

Processes for producing aqueous bromine-based biocides A) are described in U.S. Pat. Nos. 6,068,861 and 6,299,909 B1. Bromine-based biocides A) containing over 50,000 ppm of active halogen is available commercially from Albemarle Corporation under the trademark SWG® biocide (Albemarle Corporation); the pH of the aqueous product as received is normally in the range of 13 to 14.

When forming bromine-based biocide A), the pH is normally at least 7 and preferably is always at a pH higher than 7, e.g., in the range of 10-14, by use of an inorganic base. Preferred bases are alkali metal bases, preferably an oxide or hydroxide of lithium, sodium, and/or potassium, more preferably sodium hydroxide and/or potassium hydroxide. If sulfamic acid is used in forming concentrated aqueous biocidal solution, the solution should also be provided with a base, preferably enough base to keep the solution alkaline, i.e., with a pH above 7, preferably about 10 or above, and most preferably about 13 or above.

For ingredient (i) of bromine-based biocide A), bromine chloride, a mixture of bromine chloride and bromine, or a combination of bromine and chlorine in which the molar amount of chlorine is either equivalent to the molar amount of bromine or less than the molar amount of bromine is used, the aqueous biocide solution is bromine-based as most of the chlorine usually forms chloride salts such as sodium chloride since an alkali metal base such as sodium hydroxide is typically used in the processing to raise the pH of the product solution to about 13 or greater.

When a separate solution of bromine-based biocide A) is made, the active bromine content of such aqueous biocide solutions is usually about 50,000 ppm (wt/wt) or more; preferably, about 100,000 ppm (wt/wt) or more, e.g., as much as about 105,000 to about 215,000 ppm of active bromine. The pH of such separate aqueous biocide solutions is greater than 7, preferably about 10 or greater, more desirably about 12 or greater, and still more desirably about 13 or greater, and the atom ratio of nitrogen to active bromine in these separate aqueous biocide solutions is greater than 0.93.

Bromine-based biocide B) is formed in water from (i) one or more bromide sources selected from ammonium bromide, hydrogen bromide, one or more alkali metal bromides, one or more alkaline earth metal bromides, and mixtures of any two or more of the foregoing, (ii) a chlorine source, optionally (iii) at least one inorganic base, and optionally (iv) sulfamic acid and/or a metal salt of sulfamic acid. This bromine-based biocide can be made in the water to be applied to the poultry, or preferably, as a separate, more concentrated aqueous solution which is introduced into the water to be applied to the poultry. When this bromine-based biocide is prepared as a separate solution, the surfactant can be introduced into the separate solution (preferred) or into the water to be applied to the poultry. When an inorganic base is used, the pH is normally about 7 or greater and preferably is higher than 7, e.g., a pH in the range of about 10 to about 14.

For forming bromine-based biocides B), suitable bromide sources for ingredient (i) include ammonium bromide, hydrogen bromide, alkali metal bromides including LiBr, NaBr, KBr, and suitable alkaline earth metal bromides, viz., MgBr₂ and CaBr₂. Mixtures of two or more bromide sources can be used if desired. A preferred bromide source is NaBr. Mixtures of two or more bromide sources can be used if desired. A preferred bromide source is NaBr, especially NaBr from which trace amounts of alcohol such as methanol have been removed. Suitable chlorine sources for ingredient (ii) include hypochlorites, typically alkali metal hypochlorites or alkaline earth metal hypochlorites, solid chlorine sources, and chlorine (Cl₂).

In some embodiments of bromine-based biocide B), ingredient (ii) is a chlorine source which is one or more alkali metal hypochlorites and/or one or more alkaline earth metal hypochlorites, and an inorganic base, ingredient (iii), is present. The interaction of these components results in an aqueous solution having a suitably high bromine residual.

Various alkali metal hypochlorites or alkaline earth metal hypochlorites can be used as ingredient (ii), including lithium hypochlorite, sodium hypochlorite, potassium hypochlorite, calcium hypochlorite, magnesium hypochlorite, and the like; sodium hypochlorite and calcium hypochlorite are most preferred. Metal bromides or hypochlorites of Be, Sr, or Ba should not be used because of toxicological concerns. Thus, the term “alkaline earth” as used herein excludes Be, Sr, and Ba. When using ammonium bromide as ingredient (i), it is desirable to employ therewith sodium hypochlorite in the manner described in U.S. Pat. No. 6,478,973.

If an excess amount of the hypochlorite is used relative to the amount of bromide salt used, the resultant solution will contain chlorine-based species as well as a bromine residual. These chlorine-based species are not harmful as long as the requisite quantity of bromine reserve is present in the solution being used.

A commercial aqueous bromine-based biocide B) that can be utilized in practicing this invention is available under the trade designation Sta•Br•Ex® biocide (Nalco Chemical Company). This product contains active bromine stabilized against chemical decomposition and physical evaporation of active bromine species by the inclusion of sulfamate. For additional details concerning preparation of aqueous biocidal solutions of a) stabilized with sulfamic acid, see U.S. Pat. Nos. 6,007,726; 6,156,229; and 6,270,722.

Sulfamic acid and/or a metal salt of sulfamic acid is optional but preferred in some bromine-based biocides B). Metal salts of sulfamic acid are usually the alkali metal salts, including lithium sulfamate, sodium sulfamate, and potassium sulfamate. Sulfamic acid can be used alone or in a mixture with one or more metal salts of sulfamic acid. Sulfamic acid and/or sodium sulfamate are preferred.

In other preferred embodiments of bromine-based biocide B), ingredient (ii) is a solid chlorinating agent, and ingredient (iii), an inorganic base, is present. Suitable solid chlorinating agents include trichloroisocyanurate and sodium dichloroisocyanurate. Preferred inorganic bases are alkali metal bases, preferably an oxide or hydroxide of lithium, sodium, and/or potassium, more preferably sodium hydroxide and/or potassium hydroxide. In this embodiment of bromine-based biocide B), sulfamic acid and/or a metal salt of sulfamic acid is optional but preferred. Metal salts of sulfamic acid and preferences therefor are as described above.

A bromine-based biocide B) is available commercially under the trade designation BromMax® biocide (Enviro Tech Chemical Services, Inc.). This product contains active bromine stabilized against chemical decomposition and physical evaporation of active bromine species by the inclusion of sulfamate. For additional details concerning preparation of this type of bromine-based biocide B) stabilized with sulfamic acid, see U.S. Pat. Nos. 7,045,153; 7,309,503; and 7,455,859.

In another preferred embodiment of bromine-based biocide B), ingredient (iv), sulfamic acid and/or a metal salt of sulfamic acid, is present. Metal salts of sulfamic acid and the preferences therefor are as described above. In these biocides, sodium hypochlorite is most preferred as ingredient (ii), and sulfamic acid is preferred as ingredient (iv); ingredient (iii), an inorganic base, is optional but preferred. Inorganic bases and preferred inorganic bases are as described above.

Another commercial bromine-based biocide B) that can be utilized in practicing this invention is available under the trade designation Justeq07 biocide (Justeq, LLC). This product contains active halogen species stabilized by the inclusion of sulfamate. Processes for producing aqueous biocide solutions of c) are described in U.S. Pat. Nos. 6,478,972; 6,533,958; and 7,341,671.

When the water to be applied to the poultry contains a microbiocidal amount of a bromine-based biocide formed in water, typically the amount of bromine-based biocide A) and/or bromine-based biocide B) is enough to provide a bromine residual in a range of about 10 ppm to about 450 ppm (wt/wt) as free bromine, preferably in a range of about 20 to about 300 ppm (wt/wt) as free bromine, and more preferably in a range of about 35 to about 100 ppm (wt/wt) as free bromine.

Of the several types of biocides that can be used in the practice of this invention, preferred biocides include 1,3-dibromo-5,5-dialkylhydantoins, N,N′-bromochloro-5,5-dimethylhydantoins, and bromine-based biocides formed in water, especially those formed from bromine chloride or bromine chloride and bromine. More preferred biocides include 1,3-dibromo-5,5-dialkylhydantoins, especially 1,3-dibromo-5,5-dimethylhydantoin.

The surfactants used in the processes of this invention are one or more amine oxides having about eight to about twenty carbon atoms, and/or one or more betaines having about eight to about twenty carbon atoms.

The amine oxides have about eight to about twenty carbon atoms, distributed among three groups. Typically, two of the three groups are alkyl groups have one to about four carbon atoms, preferably one to about two carbon atoms. The two groups having one to about four carbon atoms are each, independently, a linear or branched alkyl group, including methyl, ethyl, n-propyl, 2-propyl, n-butyl, 2-butyl, tert-butyl, and the like. Preferably two of the three groups of the amine oxide are methyl groups.

Generally, one of the three groups of the amine oxide has about six to about eighteen carbon atoms, preferably about eight to about sixteen carbon atoms, more preferably about twelve to about sixteen carbon atoms; often this group is an alkyl group. The group having about six to about eighteen carbon atoms can be a linear or branched group, and is preferably linear. Preferred groups include those having twelve, fourteen, or sixteen carbon atoms. In some embodiments, the group having about six to about eighteen carbon atoms contains a functional group, preferably an amido group, which functional group is not bound to the amine oxide moiety. There are typically one to about five, preferably about two or about three, more preferably about three, carbon atoms between the functional group (amido group) and the amine oxide moiety.

Suitable alkyl groups having about six to about eighteen carbon atoms include 2-methylpentyl, hexyl, isohexyl, heptyl, isoheptyl, octyl, isooctyl, 2-ethylhexyl, 5,5-dimethylhexyl, nonyl, isononyl, decyl, isodecyl, 2-ethyloctyl, undecyl, 4-ethyl-3,3-dimethylheptyl, dodecyl, 3-(2-butyl)octyl, 4-propylnonyl, 5-ethyldecyl, tridecyl, tetradecyl, 3,3-dimethyldodecyl, pentadecyl, hexadecyl, heptadecyl, octadecyl, and the like. Preferred alkyl groups having about six to about eighteen carbon atoms for the amine oxide include dodecyl, tetradecyl, and hexadecyl.

Suitable groups having about six to about eighteen carbon atoms and containing a functional group include hexylamidoethyl, heptylamidobutyl, octylamidoethyl, isooctylamidomethyl, nonylamidopropyl, isononylamidobutyl, decylamidoethyl, decylamidopropyl, undecylamidoethyl, dodecylamidopropyl, dodecylamidobutyl, tridecylamidoethyl, tetradecylamidomethyl, tetradecylamidopropyl, pentadecylamidoethyl, hexadecylamidoethyl, hexadecylamidopropyl, heptadecylamidomethyl, octadecylamidomethyl, octadecylamidopropyl, and the like.

Suitable amine oxides in the practice of this invention include hexyldimethylamine oxide, heptyldimethylamine oxide, diethylheptylamine oxide, octyldimethylamine oxide, diethyloctylamine oxide, octylmethylpropylamine oxide, dimethylisooctylamine oxide, nonyldimethylamine oxide, isononyldimethylamine oxide, decyldimethylamine oxide, decyldiethylamine oxide, decylethylmethylamine oxide, dimethylundecylamine oxide, dimethyldodecylamine oxide (lauramine oxide), dodecylethylmethylamine oxide, dimethyltridecylamine oxide, dimethyltetradecylamine oxide (myristamine oxide), ethylmethyltetradecylamine oxide, dibutyltetradecylamine oxide, ethylmethylpentadecylamine oxide, dimethylhexadecylamine oxide (cetamine oxide), methylbutylhexadecylamine oxide, dimethylheptadecylamine oxide, diethylheptadecylamine oxide, dimethyloctadecylamine oxide, ethylpropyloctadecylamine oxide, methylethylhexylamidoethylamine oxide, dipropylheptylamidobutylamine oxide, dimethyloctylamidoethylamine oxide, diethylisooctylamidomethylamine oxide, methylpropylnonylamidopropylamine oxide, dimethylisononylamidobutylamine oxide, dimethyldecylamidoethylamineoxide, diethyldecylamidopropylamine oxide, dibutylundecylamidoethylamine oxide, dimethyldodecylamidopropylamine oxide, ethylpropyldodecylamidobutylamine oxide, dipropyltridecylamidoethylamine oxide, methylethyltetradecylamidomethylamine oxide, dimethyltetradecylamidopropylamine oxide, dimethylpentadecylamidoethylamine oxide, diethylhexadecylamidoethylamine oxide, dimethylhexadecylamidopropylamine oxide, diethylheptadecylamidomethylamine oxide, methylpropyloctadecylamidomethylamine oxide, dimethyloctadecylamidopropylamine oxide, and the like. Mixtures of any two or more of the foregoing may be used. Many of the amine oxides have other amine oxides present therewith, in trace amounts. For example, lauramine oxide may contain small amounts of dimethylundecylamine oxide and/or dimethyltridecylamine oxide.

Preferred amine oxides include lauryl dimethylamine oxide, myristamine oxide, and cetamine oxide; especially lauramine oxide and myristamine oxide. A preferred mixture of amine oxides is a mixture of alk-amidopropyl amine oxides having about sixteen to about eighteen carbon atoms, especially an amine oxide in which dimethyldodecylamidopropylamine oxide (lauramidopropyl amine oxide) is present in about 8 to about 16 parts per every 1 to about 4 parts of dimethyltetradecylamidopropylamine oxide (myristamidopropyl amine oxide).

The betaines have about eight to about twenty carbon atoms, distributed among three alkyl groups. Typically, two of the three alkyl groups have one to about four carbon atoms, preferably one to about two carbon atoms. The two groups having one to about four carbon atoms are each, independently, a linear or branched alkyl group, including methyl, ethyl, n-propyl, 2-propyl, n-butyl, 2-butyl, tert-butyl, and the like. Preferably two of the three groups of the betaine are methyl groups.

Generally, one of the alkyl groups of the betaine has more carbon atoms than the other two alkyl groups (the one group has a longer chain). This longer-chain alkyl group normally has about six to about eighteen carbon atoms, preferably about eight to about sixteen carbon atoms.

Suitable alkyl groups having about six to about eighteen carbon atoms include 2-methylpentyl, hexyl, isohexyl, heptyl, isoheptyl, octyl, isooctyl, 2-ethylhexyl, 5,5-dimethylhexyl, nonyl, isononyl, decyl, isodecyl, 2-ethyloctyl, undecyl, 4-ethyl-3,3-dimethylheptyl, dodecyl, 3-(2-butyl)octyl, 4-propylnonyl, 5-ethyldecyl, tridecyl, tetradecyl, 3,3-dimethyldodecyl, pentadecyl, hexadecyl, heptadecyl, octadecyl, and the like. Preferred alkyl groups having about six to about eighteen carbon atoms for the betaine include hexadecyl.

Suitable betaines in the practice of this invention include hexyldimethyl betaine, heptyldimethyl betaine, diethylheptyl betaine, octyldimethyl betaine, diethyloctyl betaine, octylmethylpropyl betaine, dimethylisooctyl betaine, nonyldimethyl betaine, isononyldimethyl betaine, decyldimethyl betaine, decyldiethyl betaine, decylethylmethyl betaine, dimethylundecyl betaine, dimethyldodecyl betaine (lauryl betaine), dodecylethylmethyl betaine, dimethyltridecyl betaine, dimethyltetradecyl betaine (myristyl betaine), ethylmethyltetradecyl betaine, dibutyltetradecyl betaine, ethylmethylpentadecyl betaine, dimethylhexadecyl betaine (cetyl betaine), methylbutylhexadecyl betaine, dimethylheptadecyl betaine, diethylheptadecyl betaine, dimethyloctadecyl betaine, ethylpropyloctadecyl betaine, and the like, and mixtures of any two or more of the foregoing. Preferred betaines include cetyl betaine.

In the practice of this invention, the surfactants can be can be blended directly into the water to be applied to the poultry. If desired, the surfactant(s) can be pre-mixed with water, and optionally with the biocide, prior to introduction into the water to be applied to the poultry.

The amount of surfactant in the water to be applied to the poultry is in a range from about its critical micelle concentration to about 10,000 ppm (wt/wt). Critical micelle concentrations are known, and are different for different surfactants. Preferably, the amount of surfactant in the water to be applied to the poultry is in a range from the critical micelle concentration to about 5000 ppm (wt/wt). Other preferred amounts of surfactant are in a range of about 20 ppm to about 10000 ppm (wt/wt), more preferably in a range of about 100 ppm to about 7500 ppm (wt/wt), still more preferably in a range of about 500 ppm to about 5000 ppm (wt/wt), even more preferably in a range of about 1000 ppm to about 5000 ppm (wt/wt), especially a range of about 2500 ppm to about 5000 ppm (wt/wt).

It is not necessary to conduct all of the steps of a process of the invention without interruption, although it is preferred to operate on a continuous basis when performing a process comprising more than one step. During the processes of this invention, one or more intervening steps can be carried out as long as the intervening step or steps do not adversely affect the benefits resulting from use of the process technology of this invention. In the practice of this invention, the washing or spraying treatment steps of the invention can involve use of sprays such as by conveying the carcasses through a spraying station or cabinet where the water treated pursuant to this invention is applied to thoroughly wet the carcasses. All of the processes and process steps of this invention are more preferably applied to mechanically transported series of poultry carcasses.

In some processes of this invention, at least one unopened defeathered poultry carcass is contacted with water containing a microbiocidal composition, whereby the exterior of said carcass is wetted by such composition. The unopened defeathered poultry carcass and the microbiocidal composition come into contact with each other, via either spraying, immersion, or other form of washing whereby the exterior of said carcass is wetted by such composition for a period of time sufficient to provide microbiocidal activity on the wet exterior of said carcass. The microbiocidal compositions are as described above.

Optional additional steps after unopened defeathered poultry carcass is contacted with water containing a microbiocidal composition include opening and eviscerating at least one of the unopened defeathered poultry carcasses that was wetted, and subjecting the opened and eviscerated poultry carcass to inside-outside washing as described below. It is not necessary to further rinse the unopened carcass before reaching the carcass opening and evisceration stage. However, a rinse with clear water before opening the carcass can be used if desired.

In some processes of this invention, inside-outside washing is a stand-alone step or process, with or without additional steps following, while in other processes of the invention, inside-outside washing is a step that follows evisceration. In either situation, at least one eviscerated poultry carcass is subjected to inside-outside washing with water containing a microbiocidal composition as described above. During inside-outside washing, both the interior cavity and the exterior of the eviscerated carcass are washed with sprays, streams, and/or floods of water; the interior and exterior washings can be conducted sequentially or concurrently.

Inside-outside washing can be effected by use of hand operated sprayers. In preferred processes, the washing is effected by use of inside-outside washing apparatus through which the carcass is conveyed, preferably with an inside-outside bird washing (IOBW) with apparatus, especially apparatus in which an inside spray probe penetrates the neck cavity from the body cavity or that creates a positive opening in the neck so that the aqueous cleansing solution used pursuant to this invention together with contaminants readily drain from the suspended carcass as it is conveyed through the apparatus. Such preferred apparatus will also apply pressurized sprays of the aqueous microbiocidal solution to the exterior of the suspended carcass by means of a manifold or array of spray nozzles so that the exterior of the carcass is also thoroughly cleansed. See for example the apparatus described in U.S. Pat. Nos. 5,482,503 and 4,849,237.

The carcass that has been subjected to inside-outside washing can be subjected to further decontamination, such as further spray rinsing in which water containing a microbiocidal composition pursuant to this invention in amounts as used to treat the water in the inside-outside washing is applied.

Another optional additional step after the inside-outside washing is the placing the carcass that was subjected to inside-outside washing in a chill tank into contact with chill water as described below.

In some processes of this invention, placing at least one poultry carcass in a chill tank is a stand-alone step or process, with or without additional steps preceding, while in other processes of the invention, placing a carcass in a chill tank is a step that follows inside-outside washing. In some of the processes of this invention, at least one eviscerated poultry carcass is placed in a chill tank and brought into contact with chill water. The processes are characterized in that the chill water contains a microbiocidal composition comprising I) one or more surfactants, and II) a microbiocidal amount of a biocide. Another way of describing these processes is as causing a poultry carcass to be placed in a chill tank and brought into contact with chill water characterized in that the chill water is treated with a microbiocidal amount of a microbiocidal composition comprising I) one or more surfactants, and II) a microbiocidal amount of a biocide. In all of these processes, the surfactants and biocides are as described above. Normally, the contact is for a period of time that is at least sufficient for the poultry carcass to reach a pre-selected low temperature. The water in the chill tank can be fresh or recirculated water, or a combination of both. Recirculated water should be effectively purged of residual impurities from prior usage before re-introduction into the chill tank.

The temperature of the chill water should be sufficiently low and the residence time of the carcass in the chill water should be sufficient to result in the carcass reaching a temperature in the range of 0 to 7° C., and preferably in the range of 1 to 5° C. The process can involve immersions in more than one chill tank containing water treated pursuant to this invention, and in such case the dosage levels of the 1,3-dibromo-5,5-dialkylhydantoin(s) can be the same or different in successive chill tanks. Also, the chill tank operations can be supplemented by use of cold sprays of either or both of water containing a microbiocidal composition pursuant to this invention and clear water.

After removing the chilled poultry carcass from the chill tank, the chilled carcass may optionally be washed with cold clear water by immersion or spraying, or both. Also optionally, after removal from the chill tank, the chilled poultry carcass can be washed with water treated with a microbiocidal amount of the microbiocidal composition of this invention. In some instances, the poultry carcass is packaged while chilled for storage or transportation under refrigeration. In other instances, it may be preferred to store the carcass under refrigeration on site, and later, when it is desired to package the carcass for sale or shipment, this can be done without further treatment.

In a preferred operation, the microbiocidal composition of this invention is applied to an unopened defeathered poultry carcass, to the eviscerated carcass during inside-outside washing of the carcass, to the eviscerated poultry carcass in the chill tank, and optionally but preferably, to the carcass after removal from the chill tank and before packaging for storage or shipment.

The term “free bromine” is used to describe the free or relatively fast-reacting forms of bromine oxidants present in aqueous solutions. In the case of the microbiocides used in the practice of this invention, total bromine is the same as active bromine. To convert “free chlorine” and “total chlorine” values (e.g., ppm Cl₂) into “free bromine” and “total bromine” values (e.g., ppm Br₂), the given concentration for “free chlorine” or “total chlorine” in terms of ppm Cl₂ is multiplied by 2.25, the molecular weight ratio of Br₂ to Cl₂. Similarly, when the given concentration of halogen is reported as Br₂, it can be converted to a Cl₂ value by dividing by 2.25, the molecular weight ratio of Cl₂ to Br₂.

The term “bromine residual” refers to the amount of bromine species present in the treated water available for disinfection. Residuals can be determined as either “free” or “total” depending upon the analytical test method employed. In the present case, the numerical values for bromine residual have been given herein on a free bromine basis. Such values can be monitored by use of the analytical procedure for “free chlorine” given below. However if desired, the bromine residual could be monitored on a “total bromine” basis by using the analytical procedure for “total chlorine” given below. In either case the numerical values obtained are in terms of chlorine and thus such values are multiplied by 2.25 to obtain the corresponding bromine values. Typically the values on a “total bromine” basis on a given sample will be higher than the values on a “free bromine” basis on the same given sample. The important point to understand is that this invention relates to the bromine residual that is actually present in the treated aqueous medium whether the value is determined by use of the free chlorine test procedure or the total chlorine test procedure, but use of the free chlorine test procedure is recommended.

Suitable methods for determining “bromine residual” are known and reported in the literature. See for example, Standard Methods For the Examination of Water and Wastewater, 18th Edition, 1992, from American Public Health Association, 1015 Fifteenth Street, NW, Washington, DC 20005 (ISBN 0-87553-207-1), pages 4-36 and 4-37; Hach Water Analysis Handbook, Third Edition, 1997, by Hach Company, Loveland Colorado, especially pages 1206 and 1207; and Handbook of Industrial Water Conditioning, 7th edition, Betz Laboratories, Inc., Trevose, PA 19047 (Library of Congress Catalog Card Number: 76-27257), 1976, pages 24-29. While these references typically refer to “chlorine residual”, the same techniques are used for determining “bromine residual”, by taking into account the higher atomic weight of bromine as compared to chlorine.

Active halogen content, whether active chlorine, active bromine, or both, is determinable by use of conventional starch-iodine titration.

A standard test for determination of low levels of active halogen is known as the DPD test and is based on classical test procedures devised by Palin in 1974. See A. T. Palin, “Analytical Control of Water Disinfection With Special Reference to Differential DPD Methods For Chlorine, Chlorine Dioxide, Bromine, Iodine and Ozone”, J. Inst. Water Eng., 1974, 28, 139. While there are various modernized versions of the Palin procedures, the recommended version of the test is fully described in Hach Water Analysis Handbook, 3rd edition, copyright 1997. The procedure for “total chlorine” (i.e., active chlorine) is identified in that publication as Method 8167 appearing on page 379, Briefly, the “total chlorine” test involves introducing to the dilute water sample containing active halogen, a powder comprising DPD indicator powder, (i.e., N,N′-diethyldiphenylenediamine, KI, and a buffer). The active halogen species present react(s) with KI to yield iodine species which turn the DPD indicator to red/pink. The intensity of the coloration depends upon the concentration of “total chlorine” species (i.e., active chlorine”) present in the sample. This intensity is measured by a colorimeter calibrated to transform the intensity reading into a “total chlorine” value in terms of mg/L Cl₂. If the active halogen present is active bromine, the result in terms of mg/L Cl₂ is multiplied by 2.25 to express the result in terms of mg/L Br₂ of active bromine.

In greater detail, the DPD test procedure is as follows:
1. To determine the amount of species present in the water which respond to the “total chlorine” test, the water sample should be analyzed within a few minutes of being taken, and preferably immediately upon being taken.
2. Hach Method 8167 for testing the amount of species present in the water sample which respond to the “total chlorine” test involves use of the Hach Model DR 2010 colorimeter. The stored program number for chlorine determinations is recalled by keying in “80” on the keyboard, followed by setting the absorbance wavelength to 530 nm by rotating the dial on the side of the instrument. Two identical sample cells are filled to the 25 mL mark with the water under investigation. One of the cells is arbitrarily chosen to be the blank. To the second cell, the contents of a DPD Total Chlorine Powder Pillow are added. This is shaken for 10-20 seconds to mix, as the development of a pink-red color indicates the presence of species in the water which respond positively to the DPD “total chlorine” test reagent. On the keypad, the SHIFT TIMER keys are depressed to commence a three minute reaction time. After three minutes the instrument beeps to signal the reaction is complete. The blank sample cell is admitted to the sample compartment of the Hach Model DR 2010, and the shield is closed to prevent stray light effects. Then the ZERO key is depressed. After a few seconds, the display registers 0.00 mg/L Cl₂. Then, the blank sample cell used to zero the instrument is removed from the cell compartment of the Hach Model DR 2010 and replaced with the test sample to which the DPD “total chlorine” test reagent was added. The light shield is then closed as was done for the blank, and the READ key is depressed. The result, in mg/L Cl₂, is shown on the display within a few seconds. This is the “total chlorine” level of the water sample under investigation. It is to be noted that the test sample may need to be diluted with halogen demand free water in order for the chlorine measurement to be within the measuring range of the instrument. This dilution will need to be taken into account to determine the actual chlorine level of the sample.
3. One method for measuring free chlorine is the Hach Method 8021. This tests for the amount of species present in the water sample which respond to the “free chlorine” test. This test involves the use of the Hach Model DR 2010 colorimeter. The stored program number for chlorine determinations is recalled by keying in “80” on the keyboard, followed by setting the absorbance wavelength to 530 nm by rotating the dial on the side of the instrument. Two identical sample cells are filled to the 25 mL mark with the water under investigation. One of the cells is arbitrarily chosen to be the blank. The blank sample cell is admitted to the sample compartment of the Hach Model DR 2010, and the shield is closed to prevent stray light effects. Then the ZERO key is depressed. After a few seconds, the display registers 0.00 mg/L Cl₂. Then, the blank sample cell used to zero the instrument is removed from the cell compartment of the Hach Model DR 2010. To the second cell, the contents of a DPD Free Chlorine Powder Pillow are added. This is shaken for 10-20 seconds to mix, as the development of a pink-red color indicates the presence of species in the water which respond positively to the DPD “free chlorine” test reagent. Immediately (within one minute of reagent addition) place the prepared sample into the cell holder. The light shield is then closed as was done for the blank, and the READ key is depressed. The result, in mg/L Cl₂, is shown on the display within a few seconds. This is the “free chlorine” level of the water sample under investigation. It is to be noted that the test sample may need to be diluted with halogen demand free water in order for the chlorine measurement to be within the measuring range of the instrument. The dilution will need to be taken into account when determining the chlorine level of the sample.

Various species of poultry can be processed pursuant to this invention. Non-limiting examples of poultry that can be processed include chicken, rooster, turkey, duck, goose, quail, pheasant, ostrich, game hen, emu, squab, guinea fowl, and Cornish hen.

An end result achievable by the practice of this invention is highly effective minimization of microbiological contamination of the meat product at all stages of the above-mentioned operations, and the provision of a meat product in which the taste, sensory quality, appearance, and wholesomeness of the product the product are not adversely affected in any material manner by the microbiocidal operations conducted pursuant to this invention. A number of literature references describe suitable methods for testing the qualities of poultry meat products, and any art-recognized procedure can be used to evaluate the taste, sensory quality, appearance, and/or wholesomeness of the product processed pursuant to this invention. One such reference is a paper of A. I. Ikeme, B. Swaminathan, M. A. Cousin, and W. J. Stadelman entitled “Extending the Shelf-Life of Chicken Broiler Meat”, Poultry Science, 1982, 61, 2200-2207.

The following examples are presented for purposes of illustration, and are not intended to impose limitations on the scope of this invention.

### EXAMPLE 1

A study was conducted in a laboratory-based poultry chill tank system, which was simulated in one-gallon (3.8 L) metal containers (cans). Five bacterially challenged chicken legs were prepared. A culture of Campylobacter jejuni strain (ATCC lot #58532167) was grown overnight in a biphasic system adapted from Shadowen, R. D., Sciortino, C. V., J. Clin. Microbiol., 1989, 27, 1744-7. In the method herein, a loop-full of fresh Campylobacter colonies were used to streak the entire surface of a Campy-cefex agar plate ([plate dimensions]; Brucella agar, 43 g/L; ferrous sulfate, 0.50 g/L; sodium metabisulfate, 0.20 g/L; pyruvic acid, 0.5 g/L; lysed horse blood cells, 50 ml/L; cycloheximide, 200 μg/L; and cefoperazone, 33 μg/L). Then Mueller Hinton broth (10 mL) was aseptically pipetted over the surface. Two or three Petri plates were prepared in this manner, and incubated overnight at 42° C. in a sealable plastic bag (Ziploc®), and flashed with a gaseous mixture (5% O₂, 10% CO₂ and 85% N₂). The following day, the liquid phase was aspirated, pelleted, washed twice in Butterfields buffer, and titrated to a concentration of 10⁸ CFU/mL. One mL of the titrated culture was spot inoculated over each chicken leg, and then each chicken leg was incubated inside a biosafety cabinet for 30 minutes at room temperature.

Each chicken leg was immersed in a separate control or test container. The containers were prefilled with 2,100 mL of either 200 ppm 1,3-dibromo-5,5-dimethylhydantoin (DBDMH; control solution) or 200 ppm DBDMH mixed with 0.4 wt % (4000 ppm) surfactant (test solution). The surfactants were lauramine oxide (Ammonyx® LO; Stepan Company), myristamine oxide (Ammonyx® MO; Stepan Company), a mixture of lauramidopropyl amine oxide and myristamidopropyl amine oxide (Ammonyx® LMDO; Stepan Company), and cetyl betaine (Amphosol® CDB; Stepan Company).

The containers were placed on an orbital shaker set at 200 rpm at 4° C. The total immersion time was 60 minutes. The solution in each container was replaced with fresh solution at a contact time of 25 to 30 minutes. The solution replacement was achieved by pouring out the liquid from the containers and refilling them with the same volume of the appropriate solution. After a total of 60 minutes incubation, the chicken legs were transferred into separate plastic bags (Ziploc®) prefilled with 36 mL of a peptone rinse solution. The chicken legs were rinsed according to the Whole Bird Rinse Method. One mL of the rinsate was removed and serially diluted in peptone buffer, followed by plating onto a Campylobacter specific agar medium for enumeration of colony forming units (CFU). The log reduction of Campylobacter for each treatment group was determined by subtracting the average log CFU remaining on the chicken legs from the average log CFU obtained from the control group. The control group consisted of 3 chicken legs that were sampled right after the bacterial challenge. Results are summarized in Table 1; Run 1 is comparative.

TABLE 1

| | DBDMH^{a} | | Log reduction of | Std. |
|---|---|---|---|---|
| Run | conc. | Surfactant (0.4 wt %) | Campylobacter | deviation |
| 1 | 200 ppm^{b} | none | 3.07 | 0.39 |
| 2 | 200 ppm | laur/myristamidopropyl | 3.63 | 0.32 |
| | | amine oxide^{c} | | |
| 3 | 200 ppm | myristamine oxide | 8.52 | |
| 4 | 200 ppm | cetyl betaine | 8.52 | |
| 5 | 200 ppm | lauramine oxide | 8.68^{d} | 0.00 |

^{a}DBDMH = 1,3-dibromo-5,5-dimethylhydantoin.
^{b}Comparative.
^{c}A mixture of lauramidopropyl amine oxide and myristamidopropyl amine oxide.
^{d}Complete kill.

### EXAMPLE 2

Experiments as described in Example 1 were performed using peracetic acid as the microbiocide. Results are summarized in Table 2; Runs A and B are comparative.

TABLE 2

| | Peracetic | | Log reduction of | |
|---|---|---|---|---|
| Run | acid conc. | Surfactant (0.4 wt %) | Campylobacter | Std. deviation |
| A¹ | 25 ppm | none | 2.78 | 0.26 |
| B¹ | 100 ppm | none | 7.01 | 2.00 |
| C | 25 ppm | lauramine oxide | 8.57² | 0.00 |

¹Comparative.
²Complete kill.

The data in Tables 1 and 2 show that complete Campylobacter eradication from chickens was achieved when 0.4% of the surfactant was applied with 200 ppm of 1,3-dibromo-5,5-dimethylhydantoin, and when 0.4% of the surfactant was applied with 25 ppm of peracetic acid.

### EXAMPLE 3—COMPARATIVE

Experiments as described in Example 1 were performed using 1,3-dibromo-5,5-dimethylhydantoin as the microbiocide. Nonionic and anionic surfactants were tested. The surfactants were an alkylpolyglucoside (Glucopon® 425N; BASF Corp.); sodium dioctyl sulfosuccinate (Aerosol® OT-100; Cytec Industries Inc.); sodium dodecyl sulfate; an ethylene oxide/propylene oxide polyether polyol copolymer (Tergitol® L-64; Dow Chemical Company); and a tri(ethylene oxide) C₁₂₋₁₅ linear alcohol ethoxylate (Biosoft® N25-3; Stepan Company). Results are summarized in Table 3.

TABLE 3

| | DBDMH^{a} | | Log reduction of | Std. |
|---|---|---|---|---|
| Run | conc. | Surfactant (0.4 wt %) | Campylobacter | deviation |
| i | 200 ppm | alkylpolyglucoside | 1.94 | 0.19 |
| ii | 200 ppm | sodium dioctyl | 1.94 | 0.19 |
| | | sulfosuccinate | | |
| iii | 200 ppm | sodium dodecyl sulfate | 2.05 | 0.15 |
| iv | 200 ppm | EO/PO polyether | 2.42 | 0.16 |
| | | polyol copolymer^{b} | | |
| v | 200 ppm | C₁₂₋₁₅ linear alcohol | 2.49 | 0.37 |
| | | ethoxylate^{c} | | |

^{a}DBDMH = 1,3-dibromo-5,5-dimethylhydantoin.
^{b}An ethylene oxide/propylene oxide polyether polyol copolymer.
^{c}A tri(ethylene oxide) C₁₂₋₁₅ linear alcohol ethoxylate.

The data in Table 3 shows that some surfactants appear to cause 1,3-dibromo-5,5-dimethylhydantoin to be less effective than using 1,3-dibromo-5,5-dimethylhydantoin by itself.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition. Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern.

The invention may comprise, consist, or consist essentially of the materials and/or procedures recited herein.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about”, the claims include equivalents to the quantities.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation in its practice. Therefore the foregoing description is not intended to limit, and should not be construed as limiting, the invention to the particular exemplifications presented hereinabove.

1. A process which comprises contacting parts of poultry resulting from processing of poultry with water containing a microbiocidal composition, characterized in that the microbiocidal composition comprises
I) one or more surfactants which is one or more amine oxides having about eight to about twenty carbon atoms, and/or one or more betaines having about eight to about twenty carbon atoms; and
II) a microbiocidal amount of: (1) one or more 1,3-dibromo-5,5-dialkylhydantoins; (2) one or more N,N′-bromochloro-5,5-dialkylhydantoins; (3) chlorine dioxide; (4) chlorine; (5) hypochlorous acid formed by electrolysis; (6) one or more alkali metal hypochlorites and/or one or more alkaline earth metal hypochlorites; (7) monochloramine; (8) peracetic acid; or (9) a bromine-based biocide formed in water from
A) (i) bromine chloride or bromine chloride and bromine, with or without conjoint use of chlorine, and (ii) overbased alkali metal salt of sulfamic acid and/or sulfamic acid, alkali metal base, and water, wherein (i) and (ii) are in relative proportions such that there is an atom ratio of nitrogen to active bromine greater than 0.93, and wherein the bromine-based biocide has a pH of greater than 7; or
B) (i) one or more bromide sources selected from ammonium bromide, hydrogen bromide, one or more alkali metal bromides, one or more alkaline earth metal bromides, and mixtures of any two or more of the foregoing, (ii) a chlorine source, (iii) optionally at least one inorganic base, and (iv) optionally sulfamic acid and/or a metal salt of sulfamic acid.

2. A process which comprises
placing at least one eviscerated poultry carcass in a chill tank and into contact with chill water, the chill water containing a microbiocidal composition, or
subjecting at least one eviscerated poultry carcass to inside-outside washing with water containing a microbiocidal composition,
characterized in that the microbiocidal composition comprises:
I) one or more surfactants which is one or more amine oxides having about eight to about twenty carbon atoms, and/or one or more betaines having about eight to about twenty carbon atoms; and
II) a microbiocidal amount of: (1) one or more 1,3-dibromo-5,5-dialkylhydantoins; (2) one or more N,N′-bromochloro-5,5-dialkylhydantoins; (3) chlorine dioxide; (4) chlorine; (5) hypochlorous acid formed by electrolysis; (6) one or more alkali metal hypochlorites and/or one or more alkaline earth metal hypochlorites; (7) monochloramine; (8) peracetic acid; or (9) a bromine-based biocide formed in water from
A) (i) bromine chloride or bromine chloride and bromine, with or without conjoint use of chlorine, and (ii) overbased alkali metal salt of sulfamic acid and/or sulfamic acid, alkali metal base, and water, wherein (i) and (ii) are in relative proportions such that there is an atom ratio of nitrogen to active bromine greater than 0.93, and wherein the bromine-based biocide has a pH of greater than 7; or
B) (i) one or more bromide sources selected from ammonium bromide, hydrogen bromide, at least one alkali metal bromide, one or more alkaline earth metal bromides, and mixtures of any two or more of the foregoing, (ii) a chlorine source, (iii) optionally at least one inorganic base, and (iv) optionally sulfamic acid and/or a metal salt of sulfamic acid.

3. A process which comprises contacting at least one unopened defeathered poultry carcass with water containing a microbiocidal composition, whereby the exterior of said carcass is wetted by such composition, characterized in that the microbiocidal composition comprises
I) one or more surfactants which is one or more amine oxides having about eight to about twenty carbon atoms, and/or one or more betaines having about eight to about twenty carbon atoms; and
II) a microbiocidal amount of: (1) one or more 1,3-dibromo-5,5-dialkylhydantoins; (2) one or more N,N′-bromochloro-5,5-dialkylhydantoins; (3) chlorine dioxide; (4) chlorine; (5) hypochlorous acid formed by electrolysis; (6) one or more alkali metal hypochlorites and/or one or more alkaline earth metal hypochlorites; (7) monochloramine; (8) peracetic acid; or (9) a bromine-based biocide formed in water from
A) (i) bromine chloride or bromine chloride and bromine, with or without conjoint use of chlorine, and (ii) overbased alkali metal salt of sulfamic acid and/or sulfamic acid, alkali metal base, and water, wherein (i) and (ii) are in relative proportions such that there is an atom ratio of nitrogen to active bromine greater than 0.93, and wherein the bromine-based biocide has a pH of greater than 7; or
B) (i) one or more bromide sources selected from ammonium bromide, hydrogen bromide, one or more alkali metal bromides, one or more alkaline earth metal bromides, and mixtures of any two or more of the foregoing, (ii) a chlorine source, (iii) optionally at least one inorganic base, and (iv) optionally sulfamic acid and/or a metal salt of sulfamic acid.

4. A process as in claim 3, which process further comprises:
opening and eviscerating at least one unopened defeathered poultry carcass that was wetted; and
subjecting the opened and eviscerated poultry carcass to inside-outside washing with water containing a microbiocidally-effective amount of microbiocidal composition
I) one or more surfactants which is one or more amine oxides having about eight to about twenty carbon atoms, and/or one or more betaines having about eight to about twenty carbon atoms; and
II) a microbiocidal amount of: (1) one or more 1,3-dibromo-5,5-dialkylhydantoins; (2) one or more N,N′-bromochloro-5,5-dialkylhydantoins; (3) chlorine dioxide; (4) chlorine; (5) hypochlorous acid formed by electrolysis; (6) one or more alkali metal hypochlorites and/or one or more alkaline earth metal hypochlorites; (7) monochloramine; (8) peracetic acid; or (9) a bromine-based biocide formed in water from
A) (i) bromine chloride or bromine chloride and bromine, with or without conjoint use of chlorine, and (ii) overbased alkali metal salt of sulfamic acid and/or sulfamic acid, alkali metal base, and water, wherein (i) and (ii) are in relative proportions such that there is an atom ratio of nitrogen to active bromine greater than 0.93, and wherein the bromine-based biocide has a pH of greater than 7; or
B) (i) one or more bromide sources selected from ammonium bromide, hydrogen bromide, at least one alkali metal bromide, one or more alkaline earth metal bromides, and mixtures of any two or more of the foregoing, (ii) a chlorine source, (iii) optionally at least one inorganic base, and (iv) optionally sulfamic acid and/or a metal salt of sulfamic acid.

5. A process as in claim 2, which process further comprises placing the carcass that was subjected to inside-outside washing in a chill tank into contact with chill water, characterized in that the chill water contains a microbiocidal composition comprising
I) one or more surfactants which is one or more amine oxides having about eight to about twenty carbon atoms, and/or one or more betaines having about eight to about twenty carbon atoms; and
II) a microbiocidal amount of: (1) one or more 1,3-dibromo-5,5-dialkylhydantoins; (2) one or more N,N′-bromochloro-5,5-dialkylhydantoins; (3) chlorine dioxide; (4) chlorine; (5) hypochlorous acid formed by electrolysis; (6) one or more alkali metal hypochlorites and/or one or more alkaline earth metal hypochlorites; (7) monochloramine; (8) peracetic acid; or (9) a bromine-based biocide formed in water from
A) (i) bromine chloride or bromine chloride and bromine, with or without conjoint use of chlorine, and (ii) overbased alkali metal salt of sulfamic acid and/or sulfamic acid, alkali metal base, and water, wherein (i) and (ii) are in relative proportions such that there is an atom ratio of nitrogen to active bromine greater than 0.93, and wherein the bromine-based biocide has a pH of greater than 7; or
B) (i) one or more bromide sources selected from ammonium bromide, hydrogen bromide, one or more alkali metal bromides, one or more alkaline earth metal bromides, and mixtures of any two or more of the foregoing, (ii) a chlorine source, (iii) optionally at least one inorganic base, and (iv) optionally sulfamic acid and/or a metal salt of sulfamic acid.

6. A process as in claim 5, which process further comprises contacting parts of poultry resulting from processing of poultry with water containing a microbiocidal composition, characterized in that the microbiocidal composition comprises
I) one or more surfactants which is one or more amine oxides having about eight to about twenty carbon atoms, and/or one or more betaines having about eight to about twenty carbon atoms; and
II) a microbiocidal amount of: (1) one or more 1,3-dibromo-5,5-dialkylhydantoins; (2) one or more N,N′-bromochloro-5,5-dialkylhydantoins; (3) chlorine dioxide; (4) chlorine; (5) hypochlorous acid formed by electrolysis; (6) one or more alkali metal hypochlorites and/or one or more alkaline earth metal hypochlorites; (7) monochloramine; (8) peracetic acid; or (9) a bromine-based biocide formed in water from
A) (i) bromine chloride or bromine chloride and bromine, with or without conjoint use of chlorine, and (ii) overbased alkali metal salt of sulfamic acid and/or sulfamic acid, alkali metal base, and water, wherein (i) and (ii) are in relative proportions such that there is an atom ratio of nitrogen to active bromine greater than 0.93, and wherein the bromine-based biocide has a pH of greater than 7; or
B) (i) one or more bromide sources selected from ammonium bromide, hydrogen bromide, one or more alkali metal bromides, one or more alkaline earth metal bromides, and mixtures of any two or more of the foregoing, (ii) a chlorine source, (iii) optionally at least one inorganic base, and (iv) optionally sulfamic acid and/or a metal salt of sulfamic acid.

7. A process as in claim 1 wherein said surfactant is an amine oxide in which two groups of the amine oxide are alkyl groups having one to about four carbon atoms, and/or wherein said surfactant is a betaine in which two groups of the betaine are alkyl groups having one to about four carbon atoms.

8. A process as in claim 7 wherein one of the groups of the amine oxide has about six to about eighteen carbon atoms, and/or wherein one of the groups of the betaine has about six to about eighteen carbon atoms.

9. A process as in claim 7 wherein said surfactant is an amine oxide in which two groups of the amine oxide are alkyl groups having one or two carbon atoms, and/or wherein said surfactant is a betaine in which two groups of the betaine are alkyl groups having one or two carbon atoms.

10. A process as in claim 8 wherein one of the groups of the amine oxide has about twelve to about sixteen carbon atoms, and/or wherein one of the groups of the betaine has about twelve to about sixteen carbon atoms.

11. A process as in claim 1 wherein the surfactant is lauramine oxide, myristamine oxide, a mixture of alk-amidopropyl amine oxides having about sixteen to about eighteen carbon atoms, or cetyl betaine.

12. A process as in claim 1 wherein the microbiocidal composition comprises one or more 1,3-dibromo-5,5-dialkylhydantoins, one or more N,N′-bromochloro-5,5-dimethylhydantoins, or a bromine-based biocide formed in water.

13. A process as in claim 12 wherein said microbiocidal composition provides a bromine residual in the range of about 10 to about 450 ppm (wt/wt) as free bromine.

14. A process as in claim 12 wherein the 1,3-dibromo-5,5-dialkylhydantoin is 1,3-dibromo-5,5-dimethylhydantoin.

15. A process as in claim 12 wherein the N,N′-bromochloro-5,5-dialkylhydantoin is N,N′-bromochloro-5,5-dimethylhydantoin.

16. A process as in claim 1 wherein the microbiocidal composition comprises peracetic acid, and wherein the peracetic acid has a concentration in the chill water in the range of about 1 ppm to about 500 ppm.

17. A process as in claim 1 wherein the microbiocidal composition comprises a bromine-based biocide formed in water from ingredients in A), and wherein:
said alkali metal base of (ii) is sodium hydroxide;
said biocide has an active bromine content is about 100,000 ppm or more; and/or
said pH is about 10 or greater.

18. A process as in claim 1 wherein the microbiocidal composition comprises a bromine-based biocide formed in water from ingredients in B), and wherein the bromine-based biocide is formed from water, (i) one or more bromide sources selected from ammonium bromide, hydrogen bromide, one or more alkali metal bromides, one or more alkaline earth metal bromides, and mixtures of any two or more of the foregoing, and
a) (ii) one or more alkali metal hypochlorites and/or one or more alkaline earth metal hypochlorites, and (iii) an inorganic base, such that the bromine-based biocide has a pH greater than 7, or
b) (ii) a solid chlorinating agent, and (iii) an inorganic base, such that the bromine-based biocide has a pH greater than 7, or
c) (ii) a chlorine source, optionally (iii) at least one inorganic base, and (iv) sulfamic acid and/or a metal salt of sulfamic acid, or
d) a combination of any one or more of a) through c).

19. A process as in claim 18 wherein (i) is sodium bromide, and/or wherein (ii) is one or more alkali metal hypochlorites.

20. A process as in claim 18 wherein
when the bromine-based biocide is a), sulfamic acid and/or a metal salt of sulfamic acid is included, (iii) is sodium hydroxide, and/or said pH is about 10 or greater;
when the bromine-based biocide is b), sulfamic acid and/or a metal salt of sulfamic acid is included, (ii) is trichloroisocyanurate or sodium dichloroisocyanurate, (iii) is sodium hydroxide, and/or said pH is about 10 or greater;
when the bromine-based biocide is c), (iv) is sulfamic acid.

21. A process as in claim 1 wherein the microbiocidal composition comprises chlorine, hypochlorous acid formed by electrolysis, one or more alkali metal hypochlorites and/or one or more alkaline earth metal hypochlorites, or monochloramine, and wherein the microbiocidal composition provides a chlorine residual in the range of about 4 to about 200 ppm (wt/wt) as free chlorine.

22. A process as in claim 21 wherein the microbiocidal composition comprises one or more alkali metal hypochlorites and/or one or more alkaline earth metal hypochlorites, and is lithium hypochlorite, sodium hypochlorite, and/or calcium hypochlorite.

23. A process as in claim 1 wherein the surfactant has a concentration in the water to be applied to poultry in the range from about its critical micelle concentration to about 10,000 ppm.
